(19) United States
(12) Patent Application Publication
(10) Pub. No.: US 2014/0074960 A1
(43) Pub. Date: Mar. 13, 2014

(54) COMPACTING A NON-BIASED RESULTS MULTISET

(71) Applicants: John Bruce Carter, Austin, TX (US); Colin Kimm Dixon, Austin, TX (US); Wesley Michael Felter, Austin, TX (US); Brent Edward Stephens, Austin, TX (US); James Xenidis, Cedar Park, TX (US)

(72) Inventors: John Bruce Carter, Austin, TX (US); Colin Kimm Dixon, Austin, TX (US); Wesley Michael Felter, Austin, TX (US); Brent Edward Stephens, Austin, TX (US); James Xenidis, Cedar Park, TX (US)

(73) Assignee: International Business Machines Corporation, Armonk, NY (US)

(21) Appl. No.: 13/609,642

(22) Filed: Sep. 11, 2012

(51) Int. Cl. G06F 12/02; G06F 15/167

(52) U.S. Cl. 709/213; 711/165; 711/E12.002

(57) ABSTRACT

A method, system, and computer program product for compacting a non-biased results multiset are provided in the illustrative embodiments. A set of references and a multiset of values are identified. The multiset includes a first and a second set of values, each set including a first value. A first reference in the set of references refers to the first set of values and a second reference in the set of references refers to the second set of values. The values in the first and second set of values are re-arranged to form permuted first and second sets of values. The multiset is compacted by overlaying the permuted first and second sets of values in a portion such that the permuted first set of values and the permuted second set of values share a single instance of the first value in a portion of the compacted multiset.

### BACKGROUND

1. Technical Field

The present invention relates generally to a method, system, and computer program product for organizing data. More particularly, the present invention relates to a method, system, and computer program product for compacting a non-biased results multiset.

2. Description of the Related Art

In some computations, one piece of data, called a key, has to be matched with another piece of data, called a result. For example, an identifier associated with a network adapter, such as a machine address, may be a key. The machine address has to be matched with one or more port numbers at a network switch that the network adapter should use for establishing communication.

Generally, any type of key can be matched with any type of data in this manner. In some cases, a key can match not just one result but a result set. A result set includes more than one result.

### SUMMARY

The illustrative embodiments provide a method, system, and computer program product for compacting a non-biased results multiset. An embodiment identifies a set of references and a multiset of values, wherein the multiset of values comprises a plurality of sets of values, wherein a first set of values and a second set of values in the plurality of sets of values each includes a first value, and wherein a first reference in the set of references refers to the first set of values and a second reference in the set of references refers to the second set of values. The embodiment re-arranges, using a processor and a memory, the values in the first set of values to form a permuted first set of values. The embodiment re-arranging the values in the second set of values to form a permuted second set of values. The embodiment compacting the multiset, to form a compacted multiset, by overlaying the permuted first and second sets of values in a portion such that the permuted first set of values and the permuted second set of values share a single instance of the first value in a portion of the compacted multiset.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an example key space and result space that can be modified using an illustrative embodiment;

FIG. 4 depicts a block diagram of a sequence of operations for compacting a non-biased results multiset in accordance with an illustrative embodiment; and

FIG. 5 depicts a flowchart of an example process for compacting a non-biased results multiset in accordance with an illustrative embodiment.

### DETAILED DESCRIPTION

When a key matches a result set, all results in the result set have equal weight. In other words, the results are non-biased in the result set such that no result is preferred over another result in the result set and any result from the result set is an equally valid match for the key.

In this manner, any number of keys in a key set can be matched with any number of results in any number of result sets. Under such circumstances one result set can include one or more results that are also present in another result set. A collection of such result sets where no uniqueness of results across result sets is required is called a results multiset. Thus, a non-biased results multiset includes result sets where some results may be present in more than one result sets and no result in a given result set has different weight or bias over another result in the given result set.

Under certain circumstances, the result space is significantly smaller than the corresponding key space. A result space is data storage space in a data processing system where a results multiset is stored. A key space is data storage space in a data processing system where a key set is stored.

For example, in the case of a network switch configuration, the number of ports on the network switch is much smaller than the number of machines that can connect via those ports. For example, hundreds of machine addresses (keys) may communicate using just sixteen ports (results) on a network switch, where a machine address may have the option to communicate using any of ports 0, 1, 2, or 3, from those sixteen ports (result set). Another machine address (another key) may similarly have the option to communicate using ports 3, 2, 6, 7, and 8 (another result set).

Ports 0-3 in the first result set are non-biased because any of those ports can provide the same service to the network adapter using the machine address key. Ports 2 and 3 occur in both result sets, therefore the two result sets are members of a results multiset.

The illustrative embodiments recognize that in circumstances where the result space is significantly smaller than the key space, a need exists to make efficient use of the result space. The illustrative embodiments recognize that presently, when the result space is significantly smaller than the key space, storing a results multiset with repetitive result values is a wasteful use of the result space. In other words, the illustrative embodiments recognize that either the available amount of result space can be utilized to store more results, or the available number of results can be stored in a reduced result space.

The illustrative embodiments used to describe the invention generally address and solve the above-described problems and other problems related to the utilization of a result space when the result space is significantly smaller than the key space. The illustrative embodiments provide a method, system, and computer program product for compacting a non-biased results multiset.

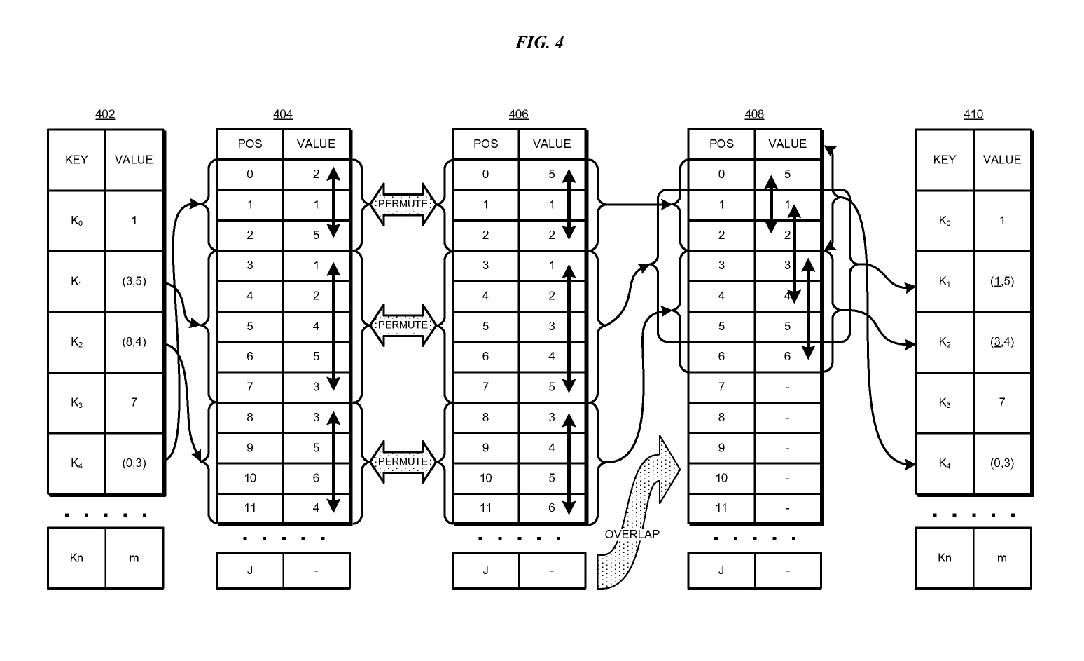

An embodiment re-arranges or orders the results in a result set such that those results that are present in one or more other result sets in the results multiset are arranged closer to an edge of the result set where the edge is shared with another result set. Other results are arranged or ordered away from such edges of the result set. FIG. 4 depicts an example that is helpful in understanding the concept of an edge of a result set according to an embodiment. An embodiment may also introduce duplicate result values in a result set to facilitate the re-arranging. For example, if a result set were to need the same value on two edges to make larger portions of the result set sharable with other result sets, an embodiment may create an additional copy of a value in the result set so that the same value can be arranged towards two edges of the result set.

The illustrative embodiments are described with respect to certain results or result values only as examples. Such descriptions are not intended to be limiting on the invention. For example, an illustrative embodiment can be implemented with respect to any alphanumeric string of any length, image data, or symbolic data, used as results in a similar manner within the scope of the illustrative embodiments.

The illustrative embodiments are described with respect to certain data, data structures, file-systems, file names, directories, and paths only as examples. Such descriptions are not intended to be limiting on the invention. For example, an illustrative embodiment described with respect to a local application name and path can be implemented as an application on a remote path within the scope of the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

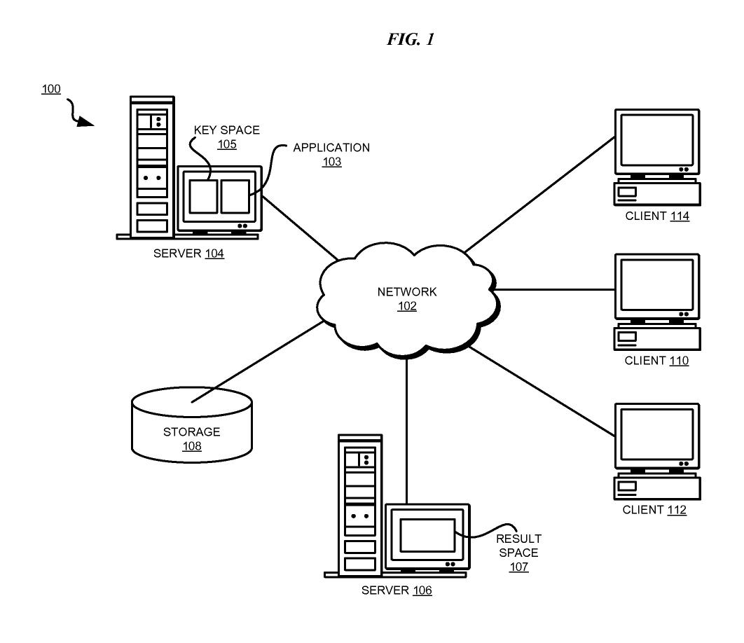

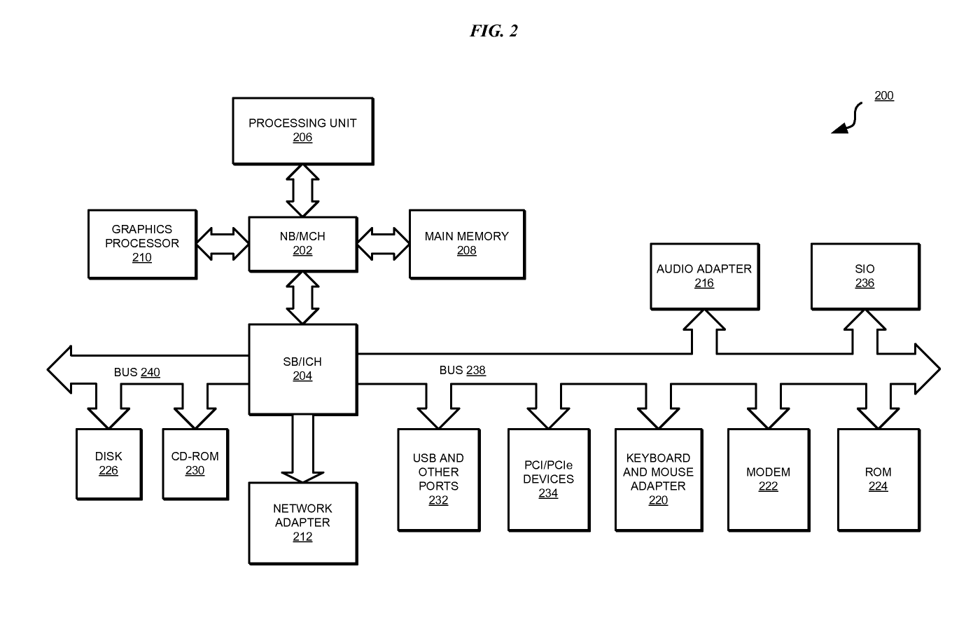

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that can be used in an embodiment. For example, server 104 includes application 103 that implements an embodiment. A data processing system, such as server 104 without implying a limitation thereto, includes key space 105, which is usable for storing and manipulating a key set in accordance with an embodiment. A data processing system, such as server 106 without implying a limitation thereto, includes result space 107, which is usable for storing and manipulating a results multiset in accordance with an embodiment.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive 226, CD-ROM 230, and other similarly usable devices are some examples of computer usable storage devices including computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft° Windows° (Microsoft and Windows are trademarks of Microsoft Corporation in the United States and other countries), or Linux° (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 103 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

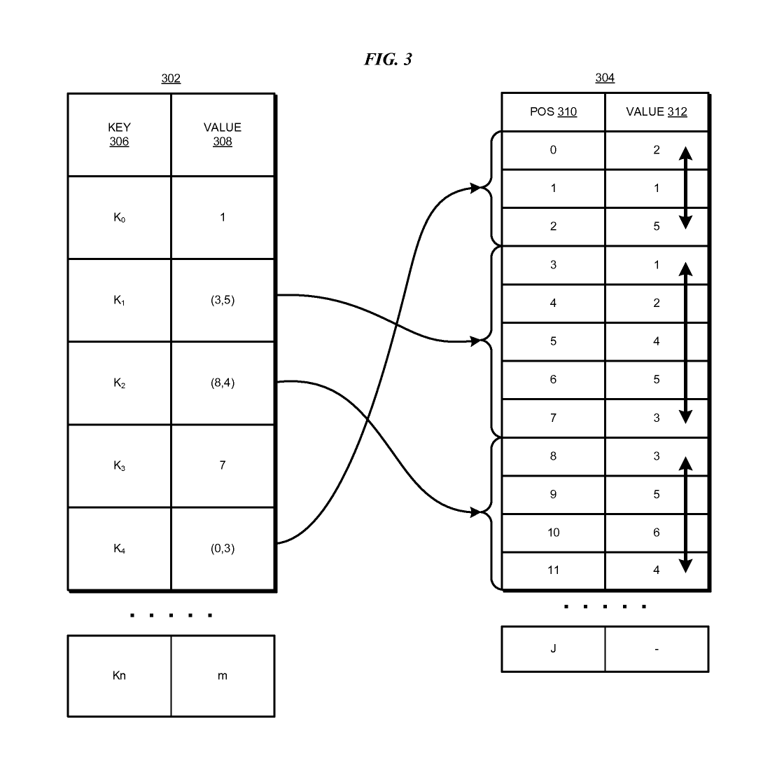

With reference to FIG. 3, this figure depicts an example key space and result space that can be modified using an illustrative embodiment. Table 302 is an example manner of depicting a key set, and can be stored and manipulated using key space 105 in FIG. 1. Table 304 is an example manner of depicting a results multiset, and can be stored and manipulated using result space 107 in FIG. 1.

0-n keys are present in key set 302. 0-j results are present in results multiset 304. Although only five numeric values (K₀₋₄) for the keys and only twelve indices for result values are depicted, values significantly larger than five or twelve, such as in the hundreds, thousands, or even more, are contemplated for n, j, or both. As described earlier, within the scope of the illustrative embodiments, the value of n is significantly larger than the value of j.

Key values in column 306 correspond to a direct value (as in the case of K₀ and K₃) or an indirect position and length value pair (as in the case of K₁, K₂, and K₄) in column 308. The position and length value pair in column 308 corresponds to a beginning position in column 310 and a number of rows of result values under column 312. The result values in those rows starting from that starting position forms a result set that corresponds to a key.

For example, key K₁ in column 306 corresponds to value pair (3,5) in column 308. Value pair (3,5) in column 308 indicates that values 1, 2, 4, 5, and 3 under column 312 in rows corresponding to the five positions 3-7, form the result set {1, 2, 4, 5, 3} corresponding to key K₁. Similarly, K₂ corresponds to result set {3, 5, 6, 4} in results multiset 304, and key K₄ corresponds to result set {2, 1, 5} in results multiset 304.

Assume that the three example result sets are designated R1={2, 1, 5}, R2={1, 2, 4, 5, 3}, and R3={3, 5, 6, 4}. R1 and R2 have results 1, 2, and 5 in common. R2 and R3 have results 3, 4, and 5 in common. R1 and R3 have result 5 in common. Presently, R1, R2, and R3 will all be stored contiguously in a linear result space, storing all values of all result sets in the result space. As can be seen twelve spaces are used for storing R1, R2, and R3, where R1, R2, and R3 include common results.

With reference to FIG. 4, this figure depicts a block diagram of a sequence of operations for compacting a non-biased results multiset in accordance with an illustrative embodiment. Table 402 represents a key set and is analogous to table 302 in FIG. 3. Table 404 represents a results multiset and is analogous to table 304 in FIG. 3. Result sets R1, R2, and R3 include results {2, 1, 5}, {1, 2, 4, 5, 3}, and {3, 5, 6, 4}, respectively, as described with respect to FIG. 3. Key K₄ corresponds to result set R1, key K₁ corresponds to result set R2, and key K₂ corresponds to result set R3, as described with respect to FIG. 3.

Table 406 provides a view of results multiset 404 after a re-arranging, ordering, or permuting operation according to an embodiment. Table 408 provides a view of results multiset 406 after an overlapping operation according to an embodiment. Table 410 provides a view of key set 402 after a reference manipulating operation according to an embodiment.

Assume, that R2 as depicted in results multiset 404 were superimposed or overlaid on R1 as depicted in results multiset 404 without any re-arranging. Result value 1 of R2 would lie on result value 2 of R1, result value 2 of R2 would lie on 1 of R1, result value 4 of R2 would lie on result value 4 of R1, and result values 5 and 3 of R2 would not lie on any result value in R1.

As can be seen, there is no overlap between R1 and R2 if overlaid in this manner. The illustrative embodiments recognize that result values 2 and 1 cannot be stored in a single memory space because they are different values, 1 and 2 cannot be stored in the same second space for the same reason, and result value 4 and 5 cannot be stored in the same third space for the same reason. R2 and R3, and R1 and R3 also cannot be overlaid in the given result space for similar reasons. Because results belonging to a result set has to be stored contiguously in the result space, storing R1, R2, and R3 takes up twelve spaces in the result space—positions 0-11—as shown in results multiset 404.

However, suppose, according to an embodiment, R1 were re-arranged, ordered, or permuted, to have the results in the following order {5, 1, 2}. Similarly, R2 were permuted or re-arranged as {1, 2, 3, 4, 5} and R3 were permuted as {3, 4, 5, 6}. Due to the permuting, result values 1 and 2 in R1 are moved closer to result values 1 and 2 of R2 so that they can overlap if R2 were overlaid on R1, one position shifted. I.e., result value 5 of R1 would occupy one space, result value 1 of R2 would occupy the next space but would also act as result value 1 of R2. Result value 2 of R1 would occupy the next space but would also act as result value 2 of R2. Other overlaps similarly follow, reducing the result space to only seven spaces positions 0-6—for storing R1, R2, and R3. The permuting operation optimizes the results space usage without any loss of results in the result sets, each result set remaining contiguous and without losing the non-biased nature of the results.

In so arranging, an embodiment moves common result values between R1 and R2, such that those common values in R1 are closer to one end of the R1 array such that a part of the R1 array can be reused as the same values in R2. The end of the R1 array can be regarded as an edge, where one or more spaces towards that end of the array form the edge of R1. Results 1 and 2 in R1 are in an edge that is shared with the edge of R2 that includes results 1 and 2. Result 5 in R1 is farthest from any shared edge and therefore no shared. Similarly, results 3, 4, and 5 in R2 are in an edge that is shared with the edge of R3 that includes results 3, 4, and 5. Result 6 in R3 is farthest from any shared edge and therefore no shared.

Key set 410 shows revised references to results sets in results multiset 408. For example, where key K₁ referenced five result values starting at position index 3 in results multiset 404, the reference is manipulated to refer to five result values starting at position index 1 in permuted and overlaid results multiset 408. Other keys in key set 410 are similarly manipulated to reference their corresponding result sets after the permuting and overlaying operations.

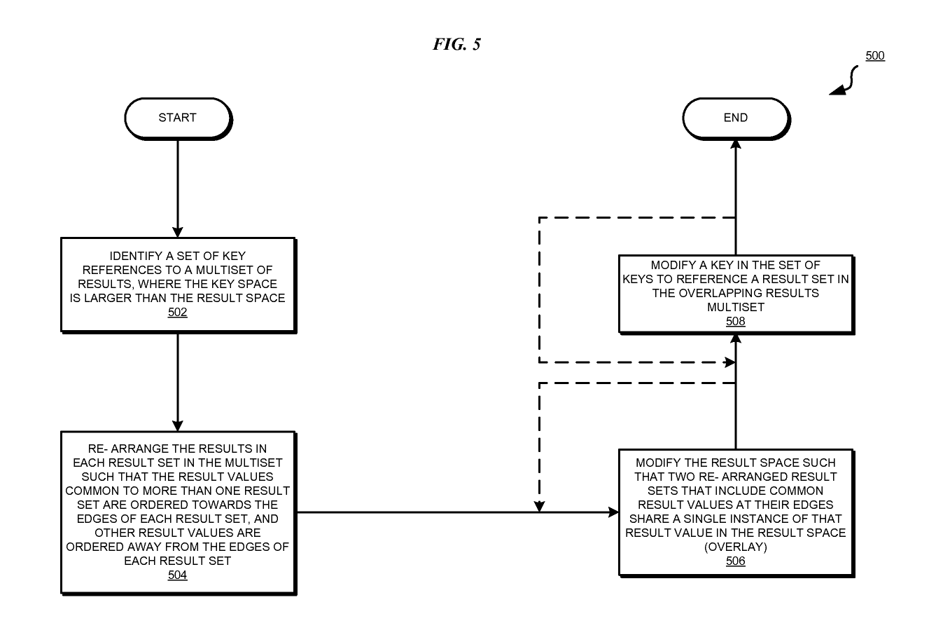

With reference to FIG. 5, this figure depicts a flowchart of an example process for compacting a non-biased results multiset in accordance with an illustrative embodiment. Process 500 can be implemented in application 103 in FIG. 1.

Process 500 begins by identifying a set of key references to a multiset of results (step 502). The key space is larger than the result space, i.e., the number of key references is significantly greater than the number of result sets in the results multiset.

Process 500 rearranges, or permutes, the results in each result set in the results multiset such that the result values common to more than one result set are ordered towards the shared edges of those result sets, and other result values in the result sets are ordered away from the shared edges (step 504). Process 500 modifies the result space such that two re-arranged result sets that include a common result value at their edges share a single instance of that result value in the result space (step 506). Process 500 may repeat step 506 for overlaying various result set pairs in this manner. Thus, through permuting and overlaying operations, the results multiset is compacted to occupy a smaller result space as compared to the original amount of result space occupied by the multiset in step 502.

Process 500 modifies a key in the key set to reference a result set in the overlapping results multiset (step 508). Process 500 may repeat step 508 to modify any number of key references in this manner. Process 500 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for compacting a non-biased results multiset. Using an embodiment, the utilization of a data storage space for storing results can be improved in those circumstances where the data storage space for storing key references exceeds the data storage space for storing the results. An embodiment compacts a results multiset by permuting the result values within the result sets in the multiset, and then overlaying the permuted result sets in some combination so that the overlaid result sets share an instance of the result values that are common among them.

An embodiment manipulates the key references to reference the overlaid result sets in the compacted results multiset.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A computer implemented method for compacting a non-biased results multiset, the method comprising:
identifying a set of references and a multiset of values, wherein the multiset of values comprises a plurality of sets of values, wherein a first set of values and a second set of values in the plurality of sets of values each includes a first value, and wherein a first reference in the set of references refers to the first set of values and a second reference in the set of references refers to the second set of values;
re-arranging, using a processor and a memory, the values in the first set of values to form a permuted first set of values;
re-arranging the values in the second set of values to form a permuted second set of values; and
compacting the multiset, to form a compacted multiset, by overlaying the permuted first and second sets of values in a portion such that the permuted first set of values and the permuted second set of values share a single instance of the first value in a portion of the compacted multiset.

2. The computer implemented method of claim 1, wherein the values in the first set of values are non-biased such that each value in the first set of values is an equally suitable value for the first reference.

3. The computer implemented method of claim 1, wherein a size of the set of references is larger than a size of the multiset.

4. The computer implemented method of claim 1, wherein the re-arranging the values in the first and the second sets of values causes the first value to occur at a first edge in the permuted first set of values and at a second edge in the permuted second set of values.

5. The computer implemented method of claim 1, further comprising:
modifying the first reference in the set of references to refer to the permuted first set of values in the portion of the compacted multiset; and
modifying the second reference in the set of references to refer to the permuted second set of values in the portion of the compacted multiset.

6. The computer implemented method of claim 1, wherein each reference in the set of references is an address associated with a networking device, each value in the multiset corresponds to a port number associated with a second networking device.

7. A computer usable program product comprising a computer usable storage medium including computer usable code for compacting a non-biased results multiset, the computer usable code comprising:
computer usable code for identifying a set of references and a multiset of values, wherein the multiset of values comprises a plurality of sets of values, wherein a first set of values and a second set of values in the plurality of sets of values each includes a first value, and wherein a first reference in the set of references refers to the first set of values and a second reference in the set of references refers to the second set of values;
computer usable code for re-arranging, using a processor and a memory, the values in the first set of values to form a permuted first set of values;
computer usable code for re-arranging the values in the second set of values to form a permuted second set of values; and
computer usable code for compacting the multiset, to form a compacted multiset, by overlaying the permuted first and second sets of values in a portion such that the permuted first set of values and the permuted second set of values share a single instance of the first value in a portion of the compacted multiset.

8. The computer usable program product of claim 7, wherein the values in the first set of values are non-biased such that each value in the first set of values is an equally suitable value for the first reference.

9. The computer usable program product of claim 7, wherein a size of the set of references is larger than a size of the multiset.

10. The computer usable program product of claim 7, wherein the re-arranging the values in the first and the second sets of values causes the first value to occur at a first edge in the permuted first set of values and at a second edge in the permuted second set of values.

11. The computer usable program product of claim 7, further comprising:
computer usable code for modifying the first reference in the set of references to refer to the permuted first set of values in the portion of the compacted multiset; and
computer usable code for modifying the second reference in the set of references to refer to the permuted second set of values in the portion of the compacted multiset.

12. The computer usable program product of claim 7, wherein each reference in the set of references is an address associated with a networking device, each value in the multiset corresponds to a port number associated with a second networking device.

13. The computer usable program product of claim 7, wherein the computer usable code is stored in a computer readable storage medium in a data processing system, and wherein the computer usable code is transferred over a network from a remote data processing system.

14. The computer usable program product of claim 7, wherein the computer usable code is stored in a computer readable storage medium in a server data processing system, and wherein the computer usable code is downloaded over a network to a remote data processing system for use in a computer readable storage medium associated with the remote data processing system.

15. A data processing system for compacting a non-biased results multiset, the data processing system comprising:
a storage device including a storage medium, wherein the storage device stores computer usable program code; and
a processor, wherein the processor executes the computer usable program code, and wherein the computer usable program code comprises:
computer usable code for identifying a set of references and a multiset of values, wherein the multiset of values comprises a plurality of sets of values, wherein a first set of values and a second set of values in the plurality of sets of values each includes a first value, and wherein a first reference in the set of references refers to the first set of values and a second reference in the set of references refers to the second set of values;
computer usable code for re-arranging, using a processor and a memory, the values in the first set of values to form a permuted first set of values;
computer usable code for re-arranging the values in the second set of values to form a permuted second set of values; and
computer usable code for compacting the multiset, to form a compacted multiset, by overlaying the permuted first and second sets of values in a portion such that the permuted first set of values and the permuted second set of values share a single instance of the first value in a portion of the compacted multiset.

16. The data processing system of claim 15, wherein the values in the first set of values are non-biased such that each value in the first set of values is an equally suitable value for the first reference.

17. The data processing system of claim 15, wherein a size of the set of references is larger than a size of the multiset.

18. The data processing system of claim 15, wherein the re-arranging the values in the first and the second sets of values causes the first value to occur at a first edge in the permuted first set of values and at a second edge in the permuted second set of values.

19. The data processing system of claim 15, further comprising:
computer usable code for modifying the first reference in the set of references to refer to the permuted first set of values in the portion of the compacted multiset; and
computer usable code for modifying the second reference in the set of references to refer to the permuted second set of values in the portion of the compacted multiset.

20. The data processing system of claim 15, wherein each reference in the set of references is an address associated with a networking device, each value in the multiset corresponds to a port number associated with a second networking device.
